(19) United States
(12) Patent Application Publication
(10) Pub. No.: US 2015/0111554 A1
(43) Pub. Date: Apr. 23, 2015

(54) FEMTO BASE STATION APPARATUS, OPERATION SYSTEM

(71) Applicant: NTT DOCOMO, INC., Chiyoda-ku, Tokyo (JP)

(72) Inventors: Hiroto Tooyama, Chiyoda-ku (JP); Kentaro Fujii, Chiyoda-ku (JP); Yuuki Kishikawa, Chiyoda-ku (JP); Satoshi Namie, Chiyoda-ku (JP); Kazuhide Takahashi, Chiyoda-ku (JP)

(73) Assignee: NTT DOCOMO, INC, Chiyoda-ku, Tokyo (JP)

(21) Appl. No.: 14/127,854

(22) PCT Filed: Feb. 8, 2013
(86) PCT No.: PCT/JP2013/000703

§ 371 Date: Dec. 19, 2013

(30) Foreign Application Priority Data
Feb. 14, 2012 (JP) 2012-029961

(51) Int. Cl. H04W 8/22

(52) U.S. Cl. CPC H04W 8/22
USPC 455/418

(57) ABSTRACT

In operation control for a femto base station apparatus, file updating is performed only for an apparatus needing updating only when needed to prevent the bandwidth of the network from being narrowed. Version information of a file necessary for the operation control for a femto base station apparatus is obtained before performing the operation control. Then, it is confirmed whether or not the obtained version information matches the version information of the file stored in the storage unit. The operation control is performed when matching is confirmed. Contrarily, a version of the file necessary for the operation control is obtained and the file updating is performed when a version confirming unit confirms mismatching of the version information.

### TECHNICAL FIELD

The present invention relates to a femto base station apparatus which is a wireless communication apparatus installed for the purpose of such as complementing an area, an operation system for instructing operation control and an operation control method.

### BACKGROUND ART

In a mobile communication system, an operation system for monitoring, controlling or the like of an apparatus constituting a mobile communication network may be installed (for example, see Non-Patent Document 1). Installing the operation system makes it possible to monitor and control a wireless base station apparatus in a remote location and the like.

On the other hand, as a wireless communication apparatus, a femto base station apparatus (it may be also referred to as femto cell base station apparatus) is known as a base station installed for the purpose of complementing a service area of a mobile communication. A technique for updating the setting of the femto base station apparatus is described in Patent Document 1. In Patent Document 1, the femto base station apparatus receives settings and updates the settings of the femto base station on the basis of the settings.

In addition, Non-Patent Document 2 is known as a technique related to firmware updating. Non-Patent Document 2 describes that the firmware updating is performed at a predetermined time automatically when the latest firmware is provided, if the type of the firmware updating is set to “automatic update”.

### PRIOR ART DOCUMENTS

### Patent Document

Patent Document 1: JP 2011-120095 A

### Non-Patent Documents

Non-Patent Document 1: “Special Article on Operation System: Operation System Development Trends in DoCoMo—Towards Efficient Operation of Networks and Improvement of Service Quality-”, NTT DoCoMo Technical Journal, (searched on Jan. 4, 2012), the Internet (URL: http://www.nttdocomo.co.jp/binary/pdf/corporate/technolog y/rd/technical_journal/bn/vol8_{—}1/vol8_{—}1_{—}006jp.pdf)

Non-Patent Document 2: “PR-220ne Router Setting Manual, Firmware Update” (searched on Jan. 4, 2012), the Internet (URL: http://router.ipq.jp/pr-200ne/post_{—}363.html)

### SUMMARY OF THE INVENTION

### Problem to be Solved

It is difficult for a carrier, i.e. telecommunications operator to have access to the femto base station apparatus, since the femto base station apparatus is often installed in a user's house. Furthermore, it is difficult for the telecommunications operator to control power on/off or its installation and the like of the femto base station apparatus, since the user may power on and off the apparatus. Therefore, the power off uncontrollable for the carrier (i.e. telecommunications operator) may happen, such as when the user performs power off operation of the femto base station apparatus or the like. In this case, file updating cannot be performed at a desired timing, and then the operation using an older revision number (an older version) of the file may continue.

It can be taken into account to confirm a revision number of the file (version information) periodically. However, even in this way, the control may not be able to be performed normally when operation control or the like is tried between periodical timings. Furthermore, it can be taken into account to shorten a period length in order to avoid such an event, however, this narrows a bandwidth of the network in a practical operation since several tens of thousands of femto base stations may be installed, and then a realistic operation becomes difficult.

As stated above, if an operator performs the file updating manually on an apparatus needing updating in order to solve the above problem, this involves a lot of efforts since it is necessary to perform the operation control for several tens of thousands of femto base station apparatus. Even if a system automatically performing the operation control remotely is constructed, the operator has to provide instructions (a program or a scenario) manually in consideration of update timings or available situations of the network or the like.

The present invention has been made in view of the above circumstances and intends to provide a femto base station apparatus, an operation system and an operation control method, capable of updating only an apparatus needing updating only when needed, to prevent the bandwidth of the network from being narrowed.

### Solution to the Problem

In order to solve the above problems, a femto base station apparatus according to an aspect of the present invention includes: a storage unit configured to store a file necessary for operation control with version information indicating a version of the file; a version information obtaining unit configured to obtain the version information of the file necessary for the operation control before performing the operation control; a version confirming unit configured to confirm whether or not the version information obtained by the version information obtaining unit matches the version information of the file stored in the storage unit; and an operation controller configured to perform the operation control when the version confirming unit confirms matching of the version information. Such a configuration makes it possible to update only an apparatus needing updating only when needed, by confirming a file version automatically before the operation. Then, it is possible to prevent the bandwidth of the network from being narrowed.

The femto base station apparatus may further includes a file obtaining unit configured to obtain the version of the file necessary for the operation control when the version confirming unit confirms mismatching of the version information. Such a configuration makes it possible to update only an apparatus needing updating only when needed, by confirming the file version automatically before the operation and by performing the file updating in the case of where the file versions are different. Then, it is possible to prevent the bandwidth of the network from being narrowed.

Furthermore, it is preferred that the version information obtaining unit obtain the version information of the file necessary for the operation control according to file version information notified before performing the operation control. Such a configuration makes it possible to update only an apparatus needing updating only when needed, by confirming the file version automatically before the operation. Then, it is possible to prevent the bandwidth of the network from being narrowed.

Furthermore, it is preferred that the version information obtaining unit obtain the version information of the file necessary for the operation control according to file version information included in an operation control instruction for performing the operation control. Such a configuration needs fewer times of signal communication between the operation system and the femto base station apparatus, since the operation control instruction including the file version information is transmitted. Then, it is possible to further prevent the bandwidth of the network from being narrowed.

Furthermore, it is preferred that the version information obtaining unit obtain the version information including major version information and minor version information, the major version information being upgraded when an improvement of the operation control or an improvement of critical security or the like is implemented, and the minor version information being upgraded in the case of a simple version upgrade not including an improvement of the operation control or an improvement of critical security or the like, and that the version confirming unit confirms whether or not only the major version information obtained by the version information obtaining unit matches the major version information of the file stored in the storage unit. Such configuration makes it possible to update only an apparatus needing updating only when needed, by performing the file updating in the case where the major versions out of the file versions are different, and by not performing the file updating in the case where the minor versions are different. Then, it is possible to further prevent the bandwidth of the network from being narrowed.

According to another aspect of the present invention, there is provided an operation system configured to perform operation control for a femto base station apparatus. The operation system includes: a file version information transmitting unit configured to transmit version information of a file necessary for the operation control to the femto base station apparatus described above before performing the operation control; and an operation controller configured to transmit an operation control instruction to the femto base station apparatus. Such a configuration makes it possible to update only an apparatus needing updating only when needed, by confirming a file version automatically before the operation. Then, it is possible to prevent the bandwidth of the network from being narrowed.

The operation system may include a file transmitting unit configured to transmit a version of file necessary for the operation control to the femto base station apparatus, when the version information of the file necessary for the operation control does not match the version information stored in the femto base station apparatus. Such a configuration makes it possible to update only an apparatus needing updating only when needed, by confirming the file version automatically before the operation and by performing the file updating in the case where the file versions are different. Then, it is possible to prevent the bandwidth of the network from being narrowed.

According to another aspect of the present invention, there is provided an operation control method including: a first step for transmitting version information of the file necessary for operation control for a femto base station apparatus to the femto base station before performing the operation control; and a second step for transmitting a version of file necessary for the operation control to the femto base station apparatus, when the version information of the file necessary for the operation control does not match the version information stored in the femto base station apparatus. Such a configuration makes it possible to update only an apparatus needing updating only when needed, by confirming the file version automatically before the operation. Then, it is possible to prevent the bandwidth of the network from being narrowed.

### Advantageous Effects of the Invention

According to the present invention, it is possible to update only an apparatus needing updating only when needed, by confirming a file version automatically before the operation and by performing the file updating in the case where the file versions are different. Then, it is possible to prevent the bandwidth of the network from being narrowed. Furthermore, by performing the file updating before the operation in the case where file versions are different, the file is surely updated to the latest version at the timing of performing the operation and the femto base station apparatus can be controlled with the latest version of file.

### BRIEF DESCRIPTION OF THE DRAWINGS

FIG. 1 is a diagram illustrating a configuration example of a network including a femto base station apparatus according to an embodiment of the present invention;

FIG. 2 is a diagram illustrating a configuration example of the femto base station apparatus in FIG. 1;

FIG. 3 is a diagram illustrating a configuration example of the operation system in FIG. 1; FIG. 4 is a diagram illustrating the first operation example of the femto base station apparatus and the operation system;

FIG. 5 is a diagram illustrating the second operation example of the femto base station apparatus and the operation system; and

FIG. 6 is a diagram illustrating the third operation example of the femto base station apparatus and the operation system.

### DESCRIPTION OF EMBODIMENTS

Hereinafter, embodiments of the present invention will be described in detail with reference to the drawings. In each of the drawings referred to with the following description, elements same as those in other drawings will be indicated by the same reference signs.

Configuration Example of Entire Network Including Femto Base Station Apparatus

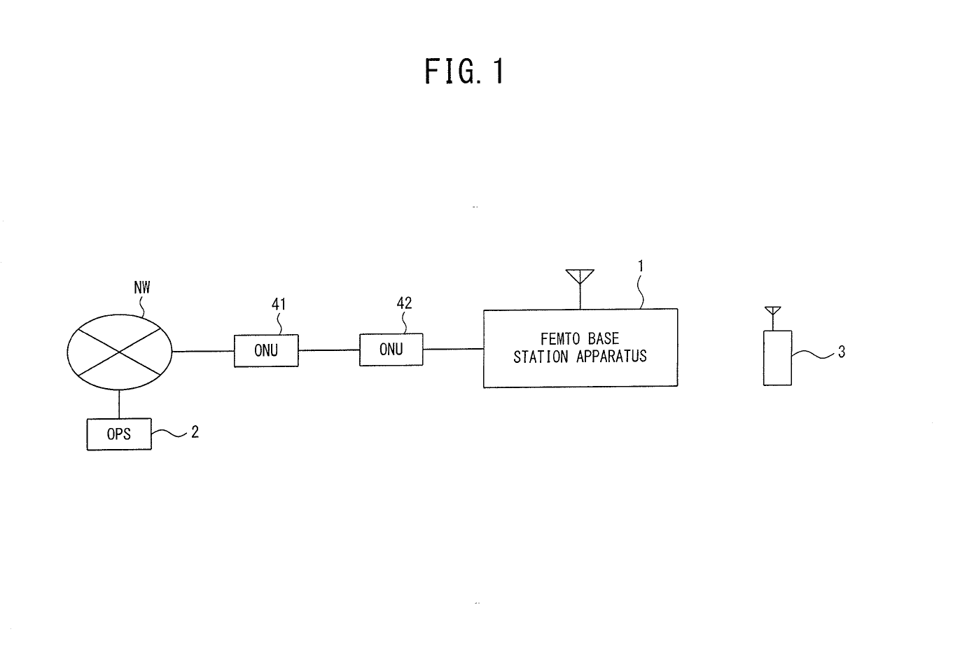

FIG. 1 is a diagram illustrating a configuration example of a network including a femto base station apparatus according to an embodiment of the present invention. In FIG. 1, the network including the femto base station apparatus according to the present embodiment includes a mobile telephone network NW, an operation system (hereinafter, referred to as OPS) 2 connected to the mobile telephone network NW, and a femto base station apparatus 1. The mobile telephone network NW and the femto base station apparatus 1 are connected to each other with an optical line via ONUs (Optical Network Unit) 41 and 42 in this example. It should be noted that the present invention may be applied in the case where the mobile telephone network NW and the femto base station apparatus 1 are not connected to each other with the optical line.

The femto base station apparatus 1 has an antenna forming a femto cell. A mobile communication terminal apparatus 3 can receive a service of the mobile telephone network NW, when the mobile communication terminal apparatus 3 is located in a femto cell provided by the femto base station apparatus 1. That is, the mobile communication terminal apparatus 3 can communicate with another apparatus (not shown) via the mobile telephone network NW, when the mobile communication terminal apparatus 3 is located in a service area of the femto cell formed by the femto base station apparatus 1.

Functional Configuration Example of Femto Base Station Apparatus

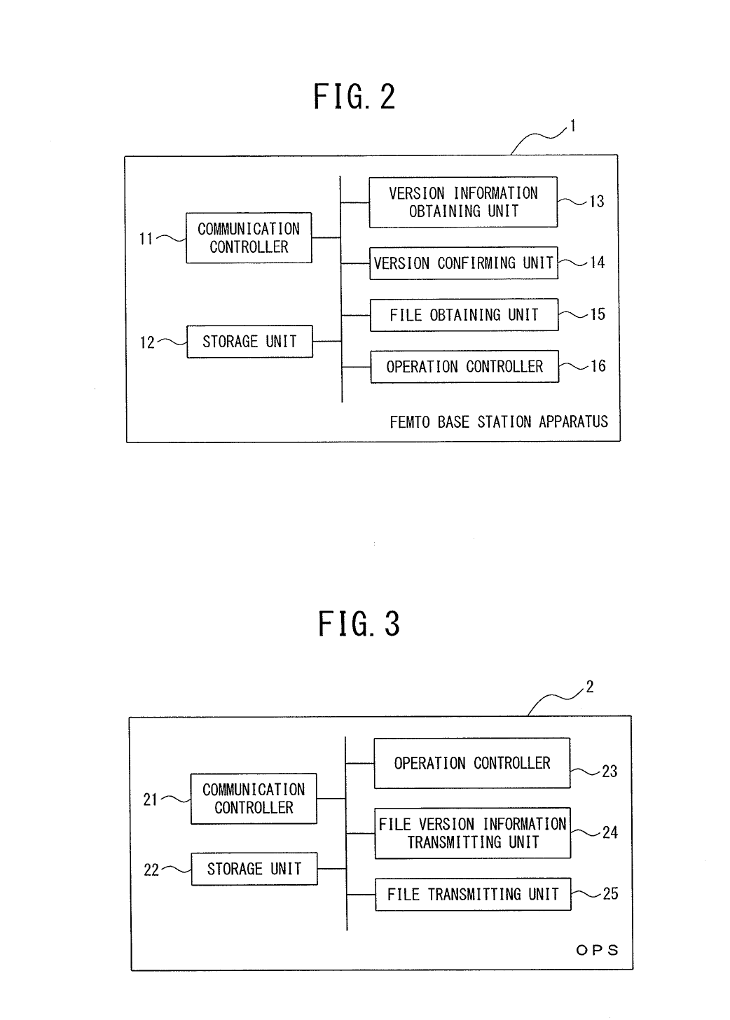

FIG. 2 is a diagram illustrating a configuration example of the femto base station apparatus 1 in FIG. 1. In FIG. 2, the femto base station apparatus 1 of the present example includes a communication controller 11 for controlling communication between the femto base station apparatus 1 and another apparatus, a storage unit 12 for storing various items of information, a version information obtaining unit 13 for obtaining the version information of a file necessary for operation control before performing the operation control, a version confirming unit 14 for confirming whether or not the version information obtained by the version information obtaining unit 13 matches the version information of the file stored in the storage unit 12, and an operation controller 16 for performing the operation control when the version confirming unit 14 confirms matching of the version information.

Here, the term “operation control” means performing reset control or application updating of the femto base station apparatus by a carrier, i.e. telecommunications operator in providing a service using the femto base station apparatus. The term “reset control” means switching a power supply into OFF state once, and into ON state again in order for recovery in the case where the femto base station apparatus falls into an abnormal state or for reflecting the updated file. The term “file updating” means updating software in order for function addition of the femto base station apparatus.

In FIG. 2, the femto base station apparatus 1 of the present example further includes a file obtaining unit 15 for obtaining a version of the file necessary for the operation control when the version confirming unit 14 confirms mismatching of the version information.

The file necessary for the operation control is stored in the storage unit 12 along with the version information indicating a version of the file.

It should be noted that the function of each of the parts described above is implemented, for example, by a program being performed by a CPU.

Function Configuration Example of OPS

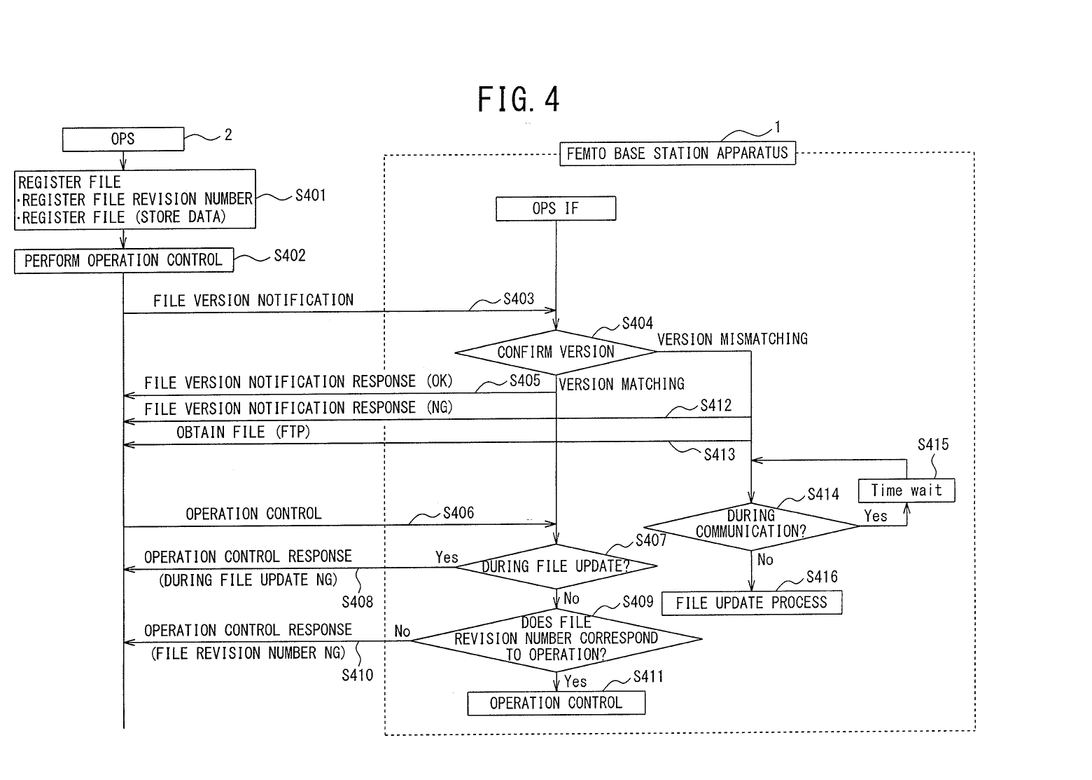

FIG. 3 is a diagram illustrating a configuration example of the OPS 2 in FIG. 1.

In FIG. 3, the OPS 2 includes a communication controller 21 for controlling communication between the OPS 2 and another apparatus, a storage unit 22 for storing various items of information, a operation controller 23 for transmitting an operation control instruction to the femto base station apparatus 1, and a file version information transmitting unit 24 for transmitting the version information of the file necessary for the operation control to the femto base station apparatus 1.

Furthermore, in FIG. 3, the OPS 2 of the present example further include a file transmitting unit 25 for transmitting version of file necessary for the operation control to the femto base station apparatus 1, when the version information of the file necessary for the operation control does not match the version information stored in the femto base station apparatus 1. The version information of the file necessary for the operation control is stored in the storage unit 22.

It should be noted that the function of each of the parts described above is implemented, for example, by a program being performed by a CPU.

Version of File

The version information of the file necessary for the operation control may have a major version and a minor version, as its version information. Settings to modify the file automatically only when the major version is upgraded can be provided (see the third operation example described below).

This makes it possible to perform controlling such that the file updating is performed only when the file of control contents performed by the operation system is changed, or only when a fatal security problem occurs. In addition, an operation that upgrades the minor version only when a maintenance person intervenes in updating, or the like is conceivable.

This makes it possible to perform the updating only when really needed even if an upgraded revision number of the file is grows frequently, therefore, the file updating frequency and a network load can be reduced.

Here, the term “major version” means a version upgraded when an improvement of the operation control, an improvement of critical security or the like is implemented. The operation may not be able to perform the control if the major version is old.

Furthermore, the term “minor version” is a version upgraded in the case of a simple version upgrade not including an improvement of the operation control, an improvement of critical security or the like.

The First Operation Example

The first operation example of the femto base station apparatus 1 and the OPS 2 will be described with reference to FIG. 4. FIG. 4 is a diagram illustrating signal communication between the femto base station apparatus 1 and the OPS 2, the operation of the femto base station apparatus 1, and the operation example of the OPS 2. Regarding the operation of the femto base station apparatus 1, the operation of an interface part with the OPS 2 (OPS IF part) is explained mainly.

At first, a file registration processing is performed in the OPS 2 (step S401). The file registration processing includes a registration processing of a file revision number (i.e. file version information), and a registration processing of the file (data) necessary for the operation control. In the file registration processing, the file version information and the file necessary for the operation control are stored in the storage unit 22.

Then, in order to perform the operation control (step S402), the file version information transmitting unit 24 in the OPS 2 transmits a notice of the file version information to the femto base station apparatus 1 (step S403). In the femto base station apparatus 1, when the communication controller 11 receives the notice of the file version information, the version information obtaining unit 13 obtains the version information of the file necessary for operation control from the storage unit 12. The version confirming unit 14 confirms whether or not the obtained version information matches the notified file version information (step S404).

As a result of confirmation by the version confirming unit 14, when the notified version information matches the version information of the file stored in the storage unit 12, the communication controller 11 in the femto base station apparatus 1 transmits a file version notification response as “OK” to the OPS 2 (from step S404 to step S405), in order to notify the OPS 2 of the matching. In the OPS 2, when the communication controller 21 receives the file version notification response, the operation controller 23 transmits the operation control instruction (step S406).

In the femto base station apparatus 1, when the communication controller 11 receives the operation control instruction, only when the operation controller 16 determines that the file is not currently being updated, and the file version corresponds to the operation control (from step S407 to S409), the operation control is performed (step S411).

When the operation controller 16 determines that the file is currently being updated, the communication controller 11 transmits an operation control response as “DURING FILE UPDATE NG” to the OPS 2 (from step S407 to step S408). Furthermore, when the operation controller 16 determines that the file version does not correspond to the operation control, the communication controller 11 transmits the operation control response as “FILE REVISION NUMBER NG” to the OPS 2 (from step S409 to step S410).

As a result of confirmation by the version confirming unit 14 in step S404, when the notified version information does not match the version information of the file stored in the storage unit 12 (in the case of mismatching), the communication controller 11 in the femto base station apparatus 1 transmits a file version notification response as “NG” to the OPS 2 (from step S404 to S412), in order to notify the OPS 2 of the mismatching. Then, the file obtaining unit 15 transmits a request for obtaining a version of the file necessary for the operation control (step S413). For example, this request is performed in accordance with the well-known FTP (File Transfer Protocol). Then, when communication is currently being performed, the file updating process waits for elapse of a predetermined time (Time Wait) (from step S414 to step S415). Then, when communication is not currently being performed, the file updating process is performed (from step S414 to step S416).

The updated file is stored in the storage unit 12 along with the version information indicating the version of the file.

According to the first operation example described above, it is possible to update only an apparatus needing updating only when needed, by automatically confirming the file version before the operation and by performing the file updating in the case where the file versions are different. Then, it is possible to prevent the bandwidth of the network from being narrowed.

The Second Operation Example

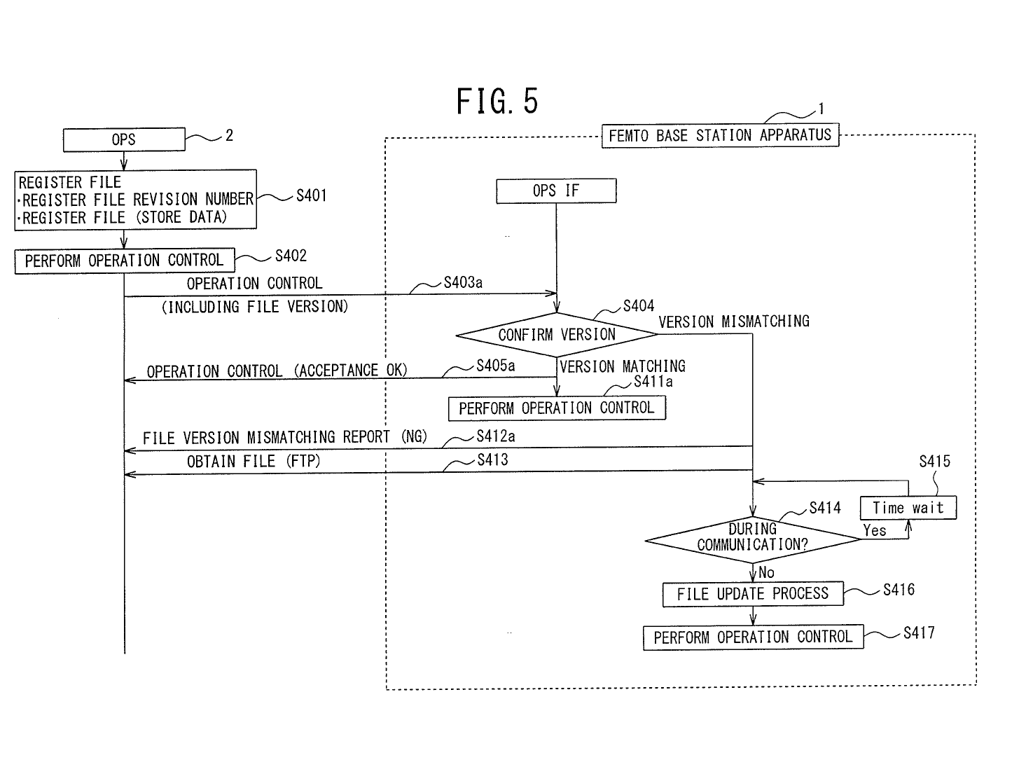

The second operation example of the femto base station apparatus 1 and the OPS 2 will be described with reference to FIG. 5. FIG. 5 is a diagram illustrating the signal communication between the femto base station apparatus 1 and the OPS 2, the operation of the femto base station apparatus 1, and the operation example of the OPS 2. Regarding the operation of the femto base station apparatus 1, the operation of the interface part with the OPS 2 (OPS IF part) is explained mainly.

In the second operation example, the operation control instruction including the file version information is transmitted from the OPS 2 to the femto base station apparatus 1. The file version information may be included in either of a header or a payload as long as the femto base station apparatus 1 can recognize the file version information.

At first, the file registration processing is performed in the OPS 2 (step S401). The file registration processing includes the registration processing of the file revision number (i.e. file version information), and the registration processing of the file (data) necessary for the operation control. In the file registration processing, the file version information and the file necessary for the operation control are stored in the storage unit 22. These steps are similar to the ones in the case of the first operation example.

Then, the operation controller 23 in the OPS 2 transmits the operation control instruction including the file version information to the femto base station apparatus 1 (step S403a), in order to perform the operation control (step S402). In the femto base station apparatus 1, when the communication controller 11 receives the operation control instruction including the file version information, the version information obtaining unit 13 obtains the version information of the file necessary for operation control from the storage unit 12. The version confirming unit 14 confirms whether or not the obtained version information matches the notified file version information (step S404).

As a result of confirmation by the version confirming unit 14, when the notified version information matches the version information of the file stored in the storage unit 12, the communication controller 11 in the femto base station apparatus 1 transmits the operation control response as “ACCEPTANCE OK” to the OPS 2 (from step S404 to S405a), in order to notify the OPS 2 of the matching. Then, the operation controller 16 performs the operation control (step S411a).

As a result of confirmation by the version confirming unit 14 in step S404, when the notified version information does not match the version information of the file stored in the storage unit 12 (in the case of mismatching), the communication controller 11 in the femto base station apparatus 1 transmits a file version notification response as “NG” to the OPS 2 (from step S404 to S412a), in order to notify the OPS 2 of the mismatching. Then, the file obtaining unit 15 transmits the request for obtaining a version of the file necessary for the operation control (step S413). For example, this request is performed in accordance with the well-known FTP (File Transfer Protocol). Then, when communication is currently being performed, the file updating process waits for elapse of a predetermined time (Time Wait) (from step S414 to step S415). Then, when communication is not currently being performed, the file updating process is performed (from step S414 to step S416) . Then, the operation controller 16 performs the operation control (step S417).

The second operation example above described needs fewer times of signal communication between the OPS 2 and the femto base station apparatus 1, since the operation control instruction including the file version information is transmitted. Then, it is possible to further prevent the bandwidth of the network from being narrowed.

The Third Operation Example

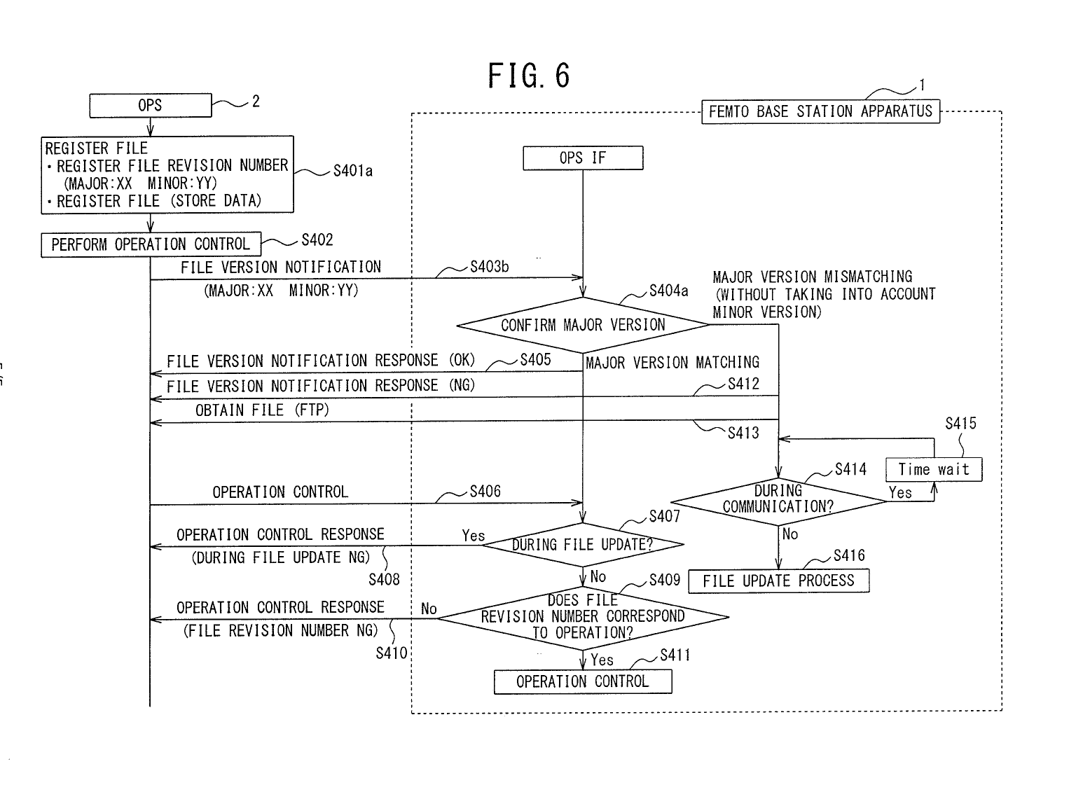

The third operation example of the femto base station apparatus 1 and the OPS 2 will be described with reference to FIG. 6. FIG. 6 is a diagram illustrating the signal communication between the femto base station apparatus 1 and the OPS 2, and also illustrating the operation of the femto base station apparatus 1 and the operation example of the OPS 2. Regarding the operation of the femto base station apparatus 1, the operation of the interface part with the OPS 2 (OPS IF part) is explained mainly.

In the third operation example, the version information of the file has a major version and a minor version, and the file is automatically modified only when the major version is upgraded.

At first, a file registration processing is performed in the OPS 2 (step S401a). The file registration processing includes the registration processing of the file revision number (i.e. file version information), and the registration processing of the file (data) necessary for the operation control. The file version information has major version information (“XX” in the present example) and minor version information (“YY” in the present example).

In the file registration processing, the file version information and the file necessary for the operation control are stored in the storage unit 22. In the registration process of a file revision number, the major version information and the minor version information are stored in the storage unit 22.

Then, in order to perform the operation control (step S402), the file version information transmitting unit 24 in the OPS 2 transmits the notice of the file version information to the femto base station apparatus 1 (step S403b). The file version information includes the major version information and the minor version information.

In the femto base station apparatus 1, when the communication controller 11 receives the notice of the file version information, the version information obtaining unit 13 obtains the version information of the file necessary for operation control from the storage unit 12. The version confirming unit 14 confirms whether or not the obtained version information matches the notified file version information (step S404a). In the confirmation, it is confirmed whether or not both of the major version information match each other, without taking into account the minor version information. That is, both items of the version information are deemed to match each other when both items of the major version information match each other, even if both items of minor version information do not match each other.

As a result of the confirmation by the version confirming unit 14, when the notified version information matches the version information of the file stored in the storage unit 12, the communication controller 11 in the femto base station apparatus 1 transmits a file version notification response as “OK” to the OPS 2 (from step S404a to step S405), in order to notify the OPS 2 of the matching. In the OPS 2, when the communication controller 21 receives the file version notification response, the operation controller 23 transmits the operation control instruction (step S406).

In the femto base station apparatus 1, when the communication controller 11 receives the operation control instruction, the operation control is performed (step S411) only when the operation controller 16 determines that the file is not currently being updated, and the file version corresponds to the operation control (from step S407 to step S409).

When the operation controller 16 determines that the file is currently being updated, the communication controller 11 transmits an operation control response as “DURING FILE UPDATE NG” to the OPS 2 (from step S407 to step S408). Furthermore, when the operation controller 16 determines that the file version does not correspond to the operation control, the communication controller 11 transmits the operation control response as “FILE REVISION NUMBER NG” to the OPS 2 (from step S409 to step S410).

As a result of confirmation by the version confirming unit 14 in step S404, when the notified version information does not match the version information of the file stored in the storage unit 12 (in the case of mismatching), the communication controller 11 in the femto base station apparatus 1 transmits a file version notification response as “NG” to the OPS 2 (from step S404 to step S412), in order to notify the OPS 2 of the mismatching. Then, the file obtaining unit 15 transmits the request for obtaining a version of the file necessary for the operation control (step S413). For example, this request is performed in accordance with the well-known FTP (File Transfer Protocol). Then, when communication is currently being performed, the file updating process waits for elapse of a predetermined time (Time Wait) (from step S414 to step S415). Then, when communication is not currently being performed, the file updating process is performed (from step S414 to step S416).

The updated file is stored in the storage unit 12 along with the version information indicating the version of the file.

According to the third operation example described above, it is possible to update only an apparatus needing updating only when needed, by automatically confirming the file versions before the operation and by performing the file updating in the case where the major versions out of the file versions are different. Then, it is possible to further prevent the bandwidth of the network from being narrowed.

Operation Control Method

In the femto base station apparatus and the OPS descried above, the following operation control method is implemented. That is, an operation control method is implemented by including: a first step for transmitting the version information of the file necessary for the operation control for a femto base station apparatus to the femto base station apparatus before performing the operation control; and a second step for transmitting the version of file necessary for the operation control to the femto base station apparatus, when the version information of the file necessary for the operation control does not match the version information stored in the femto base station apparatus.

According to the operation control method, it is possible to update only an apparatus needing updating only when needed, by automatically confirming the file versions before the operation control and by performing the file updating in the case where the file versions are different. Then, it is possible to prevent the bandwidth of the network from being narrowed.

Conclusion

By using the femto base station described above, it is possible to update only an apparatus needing updating only when needed, by automatically confirming the file versions before the operation and by performing the file updating in the case where the file versions are different. Then, it is possible to prevent the bandwidth of the network from being narrowed. Furthermore, by performing the file updating before the operation in the case where the file versions are different, the file is surely updated to the latest version at the timing of performing the operation and the femto base station apparatus can be controlled with the latest version of file.

Furthermore, it is possible to update the file only for the femto base station apparatus desired to be controlled only by registering the file in advance, and so the operator does not have to perform the file updating with taking into account the network bandwidth. For example, this eliminates the need for an automatic file updating targeting at traffic off peak hours such as a nighttime period.

Furthermore, by incorporating the version information for confirming the file version into a signal for the operation control like the second operation example described above, it is possible to eliminate the exchanges of signals in confirming the file version. Accordingly, the network load can be further reduced.

In Non-Patent Document 2 described above, the updating can be performed at the timing selected by the user (for example, update once a day). However, the update timing may be different from the timing when the operation system needs to control, thereby resulting in creation of a period of time during when normal control is difficult. Furthermore, when there are a lot of users, a new problem occurs, the problem congesting a communication line or requiring the extension of the apparatus or the like, since a lot of signals are communicated between the femto base station apparatus and the operation system.

In contrast, according to the present embodiment, the firmware updating of the apparatus can be performed at a timing when the network side needs to control. Furthermore, the bandwidth of the network can be prevented from being narrowed due to the firmware updating, since it is possible to update only an apparatus needing updating only when needed.

Furthermore, in Patent Document 1 described above, the updating process is performed from network side at a constant timing, but the version information is not confirmed. In contrast, according to the present embodiment, it is possible to update only an apparatus needing updating only when needed, by confirming the file version information and by performing the file updating in the case where the file versions are different. Then, it is possible to prevent the bandwidth of the network from being narrowed.

The scope of the present invention is not limited to the exemplary embodiments illustrated in the drawings and described, but includes all embodiments that bring equivalent effects at which the present invention aims. Moreover, the scope of the present invention is not limited to combinations of features of the invention defined by claim 1, but may include all desired combinations of features described heretofore.

### INDUSTRIAL APPLICABILITY

The present invention can be applied in the case where the operation control is performed for the femto base station apparatus.

### REFERENCE SIGNS LIST

1 femto base station apparatus

2 operation system (OPS)

3 mobile communication terminal apparatus

11 communication controller

12 storage unit

13 version information obtaining unit

14 version confirming unit

15 file obtaining unit

16 operation controller

21 communication controller

22 storage unit

23 operation controller

24 file version information transmitting unit

25 file transmitting unit

1. A femto base station apparatus comprising:
a storage unit configured to store a file necessary for operation control with version information indicating a version of the file;
a version information obtaining unit configured to obtain the version information of the file necessary for the operation control before performing the operation control;
a version confirming unit configured to confirm whether or not the version information obtained by the version information obtaining unit matches the version information of the file stored in the storage unit; and
an operation controller configured to perform the operation control when the version confirming unit confirms matching of the version information.

2. The femto base station apparatus according to claim 1, further comprising:
a file obtaining unit configured to obtain the version of the file necessary for the operation control when the version confirming unit confirms mismatching of the version information.

3. The femto base station apparatus according to claim 1, wherein the version information obtaining unit obtains the version information of the file necessary for the operation control according to file version information notified before performing the operation control.

4. The femto base station apparatus according to claim 2, wherein the version information obtaining unit obtains the version information of the file necessary for the operation control according to file version information notified before performing the operation control.

5. The femto base station apparatus according to claim 1, wherein the version information obtaining unit obtains the version information of the file necessary for the operation control according to file version information included in an operation control instruction for performing the operation control.

6. The femto base station apparatus according to claim 2, wherein the version information obtaining unit obtains the version information of the file necessary for the operation control according to file version information included in an operation control instruction for performing the operation control.

7. The femto base station apparatus according to claim 1, wherein the version information obtaining unit obtains the version information including major version information and minor version information, the major version information being upgraded when an improvement of the operation control or an improvement of critical security or the like is implemented, and the minor version information being upgraded in the case of a simple version upgrade not including an improvement of the operation control or an improvement of critical security or the like, and
wherein, the version confirming unit confirms whether or not only the major version information obtained by the version information obtaining unit matches the major version information of the file stored in the storage unit.

8. The femto base station apparatus according to claim 2, wherein the version information obtaining unit obtains the version information including major version information and minor version information, the major version information being upgraded when an improvement of the operation control or an improvement of critical security or the like is implemented, and the minor version information being upgraded in the case of a simple version upgrade not including an improvement of the operation control or an improvement of critical security or the like, and
wherein, the version confirming unit confirms whether or not only the major version information obtained by the version information obtaining unit matches the major version information of the file stored in the storage unit.

9. The femto base station apparatus according to claim 3, wherein the version information obtaining unit obtains the version information including major version information and minor version information, the major version information being upgraded when an improvement of the operation control or an improvement of critical security or the like is implemented, and the minor version information being upgraded in the case of a simple version upgrade not including an improvement of the operation control or an improvement of critical security or the like, and
wherein, the version confirming unit confirms whether or not only the major version information obtained by the version information obtaining unit matches the major version information of the file stored in the storage unit.

10. The femto base station apparatus according to claim 4, wherein the version information obtaining unit obtains the version information including major version information and minor version information, the major version information being upgraded when an improvement of the operation control or an improvement of critical security or the like is implemented, and the minor version information being upgraded in the case of a simple version upgrade not including an improvement of the operation control or an improvement of critical security or the like, and
wherein, the version confirming unit confirms whether or not only the major version information obtained by the version information obtaining unit matches the major version information of the file stored in the storage unit.

11. The femto base station apparatus according to claim 5, wherein the version information obtaining unit obtains the version information including major version information and minor version information, the major version information being upgraded when an improvement of the operation control or an improvement of critical security or the like is implemented, and the minor version information being upgraded in the case of a simple version upgrade not including an improvement of the operation control or an improvement of critical security or the like, and
wherein, the version confirming unit confirms whether or not only the major version information obtained by the version information obtaining unit matches the major version information of the file stored in the storage unit.

12. The femto base station apparatus according to claim 6, wherein the version information obtaining unit obtains the version information including major version information and minor version information, the major version information being upgraded when an improvement of the operation control or an improvement of critical security or the like is implemented, and the minor version information being upgraded in the case of a simple version upgrade not including an improvement of the operation control or an improvement of critical security or the like, and
wherein, the version confirming unit confirms whether or not only the major version information obtained by the version information obtaining unit matches the major version information of the file stored in the storage unit.

13. An operation system configured to perform operation control for a femto base station apparatus, the operation system comprising:
a file version information transmitting unit configured to transmit version information of a file necessary for the operation control to the femto base station apparatus, before performing the operation control; and
an operation controller configured to transmit an operation control instruction to the femto base station apparatus,
wherein, the femto base station comprising:
a storage unit configured to store a file necessary for operation control with version information indicating a version of the file;
a version information obtaining unit configured to obtain the version information of the file necessary for the operation control before performing the operation control;
a version confirming unit configured to confirm whether or not the version information obtained by the version information obtaining unit matches the version information of the file stored in the storage unit; and
an operation controller configured to perform the operation control when the version confirming unit confirms matching of the version information.
